(19) United States
(12) Patent Application Publication
(10) Pub. No.: US 2013/0119168 A1
(43) Pub. Date: May 16, 2013

(54) ULTRASONIC NOZZLE FOR USE IN METALLURGICAL INSTALLATIONS AND METHOD FOR DIMENSIONING A ULTRASONIC NOZZLE

(71) Applicants: Hans-Juergen Odenthal, Mettmann (DE); Jochen Schlueter, Dortmund (DE); Herbert Olivier, Aachen (DE); Igor Klioutchnikov, Aachen (DE)

(72) Inventors: Hans-Juergen Odenthal, Mettmann (DE); Jochen Schlueter, Dortmund (DE); Herbert Olivier, Aachen (DE); Igor Klioutchnikov, Aachen (DE)

(73) Assignee: SMS SIEMAG AKTIENGESELLSCHAFT, Düsseldorf (DE)

(21) Appl. No.: 13/637,827

(22) PCT Filed: Mar. 29, 2011
(86) PCT No.: PCT/EP2011/054842

§ 371 Date: Jan. 25, 2013

(30) Foreign Application Priority Data
Mar. 31, 2010 (DE) 10 2010 013 770.7
Aug. 12, 2010 (DE) 10 2010 034 210.6
Jan. 13, 2011 (DE) 10 2011 002 616.9

(51) Int. Cl. F27D 3/16; G06F 17/50

(52) U.S. Cl. CPC F27D 3/16; G06F 17/5009
USPC 239/589; 703/1

(57) ABSTRACT

The invention relates to a supersonic nozzle for use in metallurgical installations, in particular for the top blowing of oxygen in a Basic Oxygen Furnace (BOF) or an electric arc furnace (EAF), comprising a convergent portion and a divergent portion, which are adjacent to each other at a nozzle throat (DK), wherein the supersonic nozzle is defined by the following group of nozzle forms in the respective design case thereof: (T1).

### TECHNICAL FIELD

The present invention relates to a supersonic nozzle for use in metallurgical installations and a method for dimensioning such supersonic nozzle.

### PRIOR ART

Supersonic nozzles, or also Laval supersonic nozzles, have a wide field of applications in the sector of metallurgical applications. During the production of steel in a BOF converter (Basic Oxygen Furnace), oxygen is top blown onto the metal bath with the aid of a lance.

Supersonic nozzles are also used in the sector of electric arc furnaces (EAF—Electric Arc Furnace) with injectors for blowing in oxygen or with burners for melting of scrap.

A supersonic nozzle for a device for the injection of oxygen and other technical gases is known from WO00/28096 A1, for example, which can be used in metallurgical processes, in particular when melting metals. This uses a mathematical method for the design of the wall contour of the convergent and the divergent nozzle part of Laval supersonic nozzles, wherein an inverse method based upon the hyperbolic gas equations is used.

Traditional Laval supersonic nozzles are generally described in DE 101 26 100 A1, for example, which describes a method and a device for cold gas injection.

Furthermore, an integrated device for injection of technical gases and a powdery material for treating of metal baths is known from WO00/28097 A1. EP 1 506 816 A1 furthermore describes a Laval supersonic nozzle for thermal or kinetic injection.

Previous supersonic nozzles for metallurgical systems are not flow or wear optimized with respect to compression shocks or expansion waves inside of the supersonic nozzle. The service life of current lances is approximately 150-250 melts in the converter, for example. At the end of this period, the nozzle edges are worn to such an extent that there is a risk of a water breakthrough in the water-cooled supersonic nozzle, and the lance heads must be replaced.

### DESCRIPTION

The purpose of the present invention correspondingly is to indicate a supersonic nozzle for use in metallurgical installations as well as a method for determining the parameters by means of which the wear of supersonic nozzles can be reduced.

This problem is solved by means of a supersonic nozzle pursuant to the Claims with the features stated below.

Accordingly, a supersonic nozzle for use in metallurgical installations is provided, in particular for the top blowing of oxygen in a basic oxygen furnace (BOF), in an argon oxygen decarburization (AOD) converter (argon oxygen decarburization), or in an electric arc furnace (EAF) with a convergent part and a divergent part, which are adjacent to each other at a nozzle throat. The supersonic nozzle is defined by the following group of nozzle forms in their respective design case.

| | | Radius in the | | max. |
|---|---|---|---|---|
| | Volumetric | narrowest | Exit | nozzle |
| Pressure p₀ | flow V₀ | cross-section | radius rₑ | length |
| in bar | in NmVmin | r* in mm | in mm | 1 in mm |
| 4 | 20 | 12.0 | 14.0 | 50 ± 20 |
| 4 | 200 | 39 | 44.0 | 160 ± 20 |
| 14 | 20 | 6 | 10.0 | 50 ± 20 |
| 14 | 200 | 21 | 33.0 | 160 ± 20 |

This problem is furthermore solved by a supersonic nozzle for use in metallurgical installations, in particular for the top blowing of oxygen in a basic oxygen furnace (BOF), in an argon oxygen decarburization (AOD) converter (argon oxygen decarburization), or in an electric arc furnace (EAF) with a convergent part and a divergent part, which are adjacent to each other at a nozzle throat. The inner contour of the supersonic nozzle corresponds to the contour determined numerically with a modified method of characteristic curves.

The inner contour of the supersonic nozzle corresponds in particular to the determined contour, which is determined by the numeric solution of the partial gas dynamic differential equations, by means of which the stationary, isentropic, axisymmetrical gas flow is represented by means of spatially discretized characteristic equations, taking into account corresponding conditions of compatibility. In the literature, this method is also known as “Method of Characteristic Curves” or “Method of Characteristics.”

In other words, an associated radial value (r-position) is determined for each axial position (x-position) along the supersonic nozzle such that an interference-free gas flow is formed within the supersonic nozzle. That is to say that the wall contour in the expansion part of the supersonic nozzle cannot be determined by a unique mathematical function.

When the supersonic nozzles are operated in the design state by means of the correspondingly determined supersonic nozzles, it can be accomplished that the oxygen jet inside and outside of the supersonic nozzle has none or only very few pressure irregularities. Accordingly, the expanding gas jet is also very close to the nozzle contour and therefore cools the nozzle wall. Furthermore, this behavior makes undesirable flow separation in the vicinity of the nozzle outlet more difficult, so that the wear characteristics of the supersonic nozzle are improved in the design point. Wear optimization can be accomplished in this manner, because the cooling of the supersonic nozzle is improved because of the better internal flow characteristics as well as a result of the reduced tendency of flow separation in the outlet area.

By contouring the supersonic nozzle pursuant to the present disclosure it is achieved furthermore that the nozzle length can be reduced by roughly 20-30% while the jet characteristics are improved, by which expensive copper material is saved, the weight of the supersonic nozzle is reduced, and the installation depth is reduced. Accordingly, the lance or the injector or the burner can be designed to be smaller and lighter, which will simplify the installation and/or the handling of same.

CFD simulations (CFD—Computational Fluid Dynamics) have moreover proven that the jet velocity along the jet axis for the supersonic nozzle is increased by approximately 3-5% pursuant to the present disclosure. But this also increases the length of the usable supersonic region of the jet.

The result is that the supersonic nozzle designed according to the present disclosure has been improved not just in terms of the wear characteristics, but also in terms of the consumption of material, the installation characteristics, the handling as well as its effectiveness compared to conventional supersonic nozzles.

The supersonic nozzles pursuant to the present disclosure can be used for injectors, burners, lances, etc., for example, for defined use in metallurgical installations (electric arc furnace, reduction furnace, converter, steel casting ladle, etc.).

The ratio of the nozzle length l to the radius is preferably in the narrowest cross-section r*, i.e. the ratio l/r* is between 2.1 and 11.6, preferably between 2.1 and 8.3, even more preferably between 2.1 and 5.4, and even still preferably between 2.1 and 5.0, and in particular comprises values of 11.6; 8.3; 5:4; 5.0; 4.8; 4.2; 4.1; 3.6; 3.3; 3.1 or 2.1. The narrowest cross-section in the present supersonic nozzles is in the nozzle throat. By using the appropriate nozzle geometry, shorter supersonic nozzles can be produced compared to conventional nozzles.

In a further preferred embodiment, the convergent part of the supersonic nozzle comprises a bell-shaped contour, wherein the bell-shaped contours of the convergent part and the divergent part are continuously merging into one another on the nozzle throat. The bell-shaped contour ensures that the nozzle can be used trouble-free and will have low wear, that the jet impulse at the nozzle outlet is at its maximum, and that a long supersonic length of the gas jet will be realized.

### BRIEF DESCRIPTION OF THE DRAWINGS

In the following, the present disclosure will be explained once again in detail based upon the enclosed Figures. The Figures show:

FIG. 1 shows the basic Mach number distribution inside and outside of a Laval supersonic nozzle that is operated with oxygen;

FIG. 2 shows axisymmetrical, half geometries of a Laval supersonic nozzle for a conventional Laval supersonic nozzle (A) and for a Laval supersonic nozzle pursuant to the present disclosure (B);

FIG. 3 shows the result of a CFD simulation for a traditional supersonic nozzle (A) and a Laval supersonic nozzle pursuant to the present disclosure (B);

FIG. 4 shows different plots of a Laval supersonic nozzle pursuant to the present disclosure (ranges, radii, characteristics);

FIG. 5 shows different calculations of the geometry of a Laval supersonic nozzle pursuant to the present disclosure;

FIG. 6 shows a table, from which the geometries of two Laval supersonic nozzles pursuant to the present disclosure result directly.

### DETAILED DESCRIPTION OF THE DRAWINGS

Below, two different embodiments of the present disclosure are described, wherein the same reference symbols are used for identical or similar components, and where a repeated description is dispensed with.

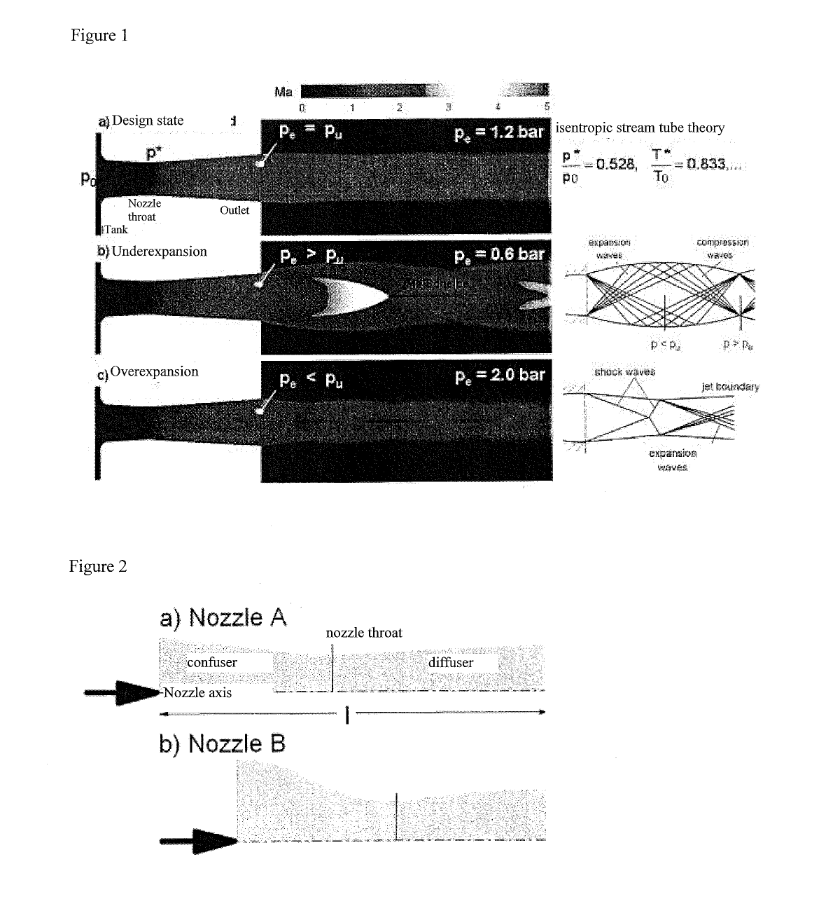

FIG. 1 shows the basic Mach number distribution inside and outside of a Laval supersonic nozzle that is operated with oxygen. In this instance, the oxygen enters into an atmosphere at 1650° C.

It becomes clear that in the design state shown in FIG. 1a, that is when pressure at the outlet cross-section pₑ is equal to the ambient pressure pᵤ, an interference-free flow is essentially accomplished.

FIG. 1b shows an underexpansion, in which the ambient pressure pᵤ is smaller than the pressure at the outlet cross-section pₑ. Here it can be clearly recognized that a faulty jet trajectory is present.

FIG. 1b shows an overexpansion, that is at which the ambient pressure pᵤ is greater than the pressure at the outlet cross-section pₑ. A faulty jet trajectory exists also in this case.

This illustration already clearly shows that a supersonic nozzle, which is not operated in its design state, will always have a faulty jet trajectory. Only a supersonic jet that is operated in its design state can have a smooth jet trajectory.

FIG. 2A shows a conventional Laval supersonic nozzle A which comprises a smooth convergent inlet area, an essentially consistent nozzle throat, as well as a smooth divergent discharge area. The overall length of the jet is l=142 mm.

FIG. 2B shows the Laval supersonic nozzle pursuant to the present disclosure which has curved walls which are bell-shaped both in the convergent inlet area as well as in the divergent outlet area. The length of the jet is l=100 mm.

A curved wall that is bell-shaped is to be understood as a wall in which the wall contour changes from a concave area to a convex area, and correspondingly has an inflection point. This is the case with the supersonic nozzle shown in FIG. 2B; here, the shape of the wall coming from the left along the direction of flow has a concave shape which then merges into a convex shape. The run from the area of the nozzle throat DK initially goes through a convex area, which in a concave area towards the cross-section AQ becomes concave again once it has passed the inflection point WP. Accordingly, pursuant to the supersonic nozzle of the present disclosure, both the convergent area as well as the divergent area each have a bell shape. The bell-shaped convergent area and the bell-shaped divergent area continuously abut one another in the nozzle throat DK, so that the wall contour is continued smoothly at this location.

During the production of steel in a BOF converter (Basic Oxygen Furnace), the oxygen is top blown onto the metal bath with the aid of a lance. Several convergent/divergent supersonic nozzles (Laval nozzles) are arranged at a certain angle in the head of the lance, which accelerate the oxygen to supersonic velocity. FIG. 1A illustrates such supersonic nozzle. The number of supersonic nozzles in the head of the lance depends on the flow rate; typically, 5 to 6 supersonic nozzles are located in the head. The oxygen discharges from the supersonic nozzle with approximately double the velocity of sound and a high impulse and then impacts the melt after approximately 1.5 m to 3.0 m, depending upon the distance of the lance above the molten bath. There, it creates an oscillating blow trough and thus ensures an intensive decarburization reaction. The lance head of the lance is cast or forged from copper and is water-cooled, wherein the feed is by means of an annular channel inside of the lance and the return flow is by means of an annular channel in the outside of the lance.

As a result of the expansion of the oxygen in the divergent nozzle part of the supersonic nozzle, the gas cools down to approximately −100° C., so that the lance head is also cooled from the gas side. As long as the jet bears tightly against the nozzle wall, the cooling water supply is maintained and no slag formation is present on the lance, nozzle wear is small. The typical service life of lances currently is approximately 150 to 250 melts in the converter.

A similar application for supersonic nozzles can be found with injectors for injecting oxygen or burners for melting of scrap in electric arc furnaces (EAF). With respect to the injector/burner, this is one and the same unit, where only the mode of operation is different. The unit consists of a central supersonic nozzle that is surrounded by an annular gap nozzle.

In the injector mode, pure oxygen is blown through the supersonic nozzle and hot flue gas (CO₂) through the annular gap nozzle. As a result of the annular, hot enveloping gas jet, one would hope that the central oxygen jet remains stable across a greater length, thereby achieving large supersonic lengths. Oxygen will also be conveyed via the central supersonic nozzle in the burner mode, but in addition natural gas (CH₄) is conveyed via the annular gap, which results in a stoichiometric combustion with sustained flame formation outside of the nozzle.

In the injector mode, i.e. during blowing on oxygen via the central supersonic nozzle onto the surface of the melt, the primary objective is to decarburize the melt as quickly as possible, but at the same time also create effective foaming slag in the EAF, in order to shield the surrounding furnace geometry (cooling panels) against the extremely hot electric arc radiation. Since the oxygen injector is installed in a furnace panel positioned in front, and is arranged at a certain angle of approximately 40°, the oxygen jet may possibly have to go across long distances up to 3 m, in order to reach the melt surface. It is therefore important to generate a coherent supersonic jet that is as long as possible and to strike the melt surface with a high jet impulse. Only under these circumstances proper decarburization is possible together with intensive mixing of the melt. So that the supersonic length is as long as possible, the gas jet must have no irregularities either inside or outside of the supersonic nozzle, which is the case, however, if the nozzle wall contour is inadequately designed. At the same time, the supersonic nozzle must have a long service life.

Nozzle wear basically depends on two factors:

### a) Upstream Pressure/Volumetric Flow Rate

Each supersonic nozzle can only be configured for one operating point regarding the upstream pressure pₒ, the volumetric flow rate Vₒ and the ambient pressure pᵤ in the metallurgical unit. These parameters are constantly controlled during operation, so that the actual nozzle flow deviates from the ideal design state for varying time periods. As a consequence thereof, complex interference patterns (diamond patterns) are forming inside and outside of the supersonic nozzle in the form of expansion waves and compression shocks, which result in nozzle edge wear. An example of this is also shown in the drawings on the right side of FIG. 1.

A reduction in the upstream pressure pₒ below the design pressure is particularly critical, since oblique compression shocks on the nozzle edge result in the detachment of the cold oxygen jet from the nozzle wall and a recirculation area is formed, by means of which the hot converter gas reaches the copper wall. It is exactly at this position that the nozzle wear begins, irrespective of whether the water cooling is working properly. Once this local wear in the divergent nozzle part has started, this position is increasingly subjected to the effects of hot converter gas during the continued converter operation. The copper wears increasingly more, due to the recirculation area that continuously becomes larger, and the risk of a water breakthrough increases.

FIG. 1 shows the fundamental influence that the ambient pressure pᵤ has on the Mach number distribution. The supersonic nozzle is considered as having not been adapted, if the pressure pₑ in the outlet cross-section is dissimilar to the ambient pressure pᵤ, wherein the ambient pressure pᵤ is the static pressure in the converter or in the electric arc furnace, for example. Contrary to the subsonic jet, which will always exit at constant pressure on the nozzle tip, because the orifice pressure has a regulating effect on the flow, the supersonic jet has the capability of discharging not only against constant pressure and against any negative pressure however strong, but also up to a certain degree against excess pressure.

If pₑ>pᵤ, see underexpansion in FIG. 1b, this requires post-expansion downstream of the outlet cross-section. Expansion fans are attached on the nozzle outlet edge and the jet expands outside of the supersonic nozzle. The intersecting waves of the expansion fan will be reflected as compression waves on the open jet boundary. The pressure in the core of the jet downstream of the expansion waves is smaller than the ambient pressure, and is larger than the ambient pressure downstream of the compression waves. The periodic interaction of expansion and compression continues until the subsonic speed is reached.

If pₑ<pᵤ, see overexpansion in FIG. 1c, a system made up of oblique compression shocks starts out from the outlet edges of the supersonic nozzle. A compression shock is connected with a discontinuous change of the parameters p, T, ρ, s, Ma and u; while p, T, ρ and s are increasing, Ma and u are dropping. Subsonic velocity always exists behind the vertical compression shock. The open jet is constricted and the pressure in the core of the jet increases downstream to values above the counter pressure. The compression waves are reflected on the edge of the open jet of the gas jet as expansion waves, and the static pressure in the jet drops. This process repeats itself periodically, until the growing mixing zones on the edge of the jet control the flow field and the supersonic jet is converted into a subsonic jet.

Whether pᵤ or pₒ is varied is not really important, because the reciprocally tuned values p*/pₒ and A*/Aₑ of the design state are changed in each case.

b) Nozzle Geometry

The nozzle geometry has a similar influence on the formation of irregularities in the oxygen jet. Supersonic nozzles for lances or for the burner/injector technology were previously nearly always produced with axisymmetrical, level, i.e. cone-shaped walls in the convergent part and divergent part, see FIG. 2, supersonic nozzle A. In the center section, the so-called nozzle throat, there is normally an approximately 20 mm long area with a constant diameter. This form is decided for reasons of production engineering, and is determined by manufacturers using the isentropic stream tube theory, which assumes an isentropic (reversible adiabatic), uni-dimensional flow along a single stream filament in the supersonic nozzle. This method has shortcomings, because in principle neither influences of friction because of the boundary layer close to the wall nor three-dimensional flow effects within the supersonic nozzle are taken into account. Because of the nozzle geometry which is then not optimized, the previously described irregularities in the physical parameters for the pressure, the velocity, the temperature and the density are formed. If these irregularities are reflected on the nozzle wall, this will result in flow separation with premature nozzle wear as well as an inefficient gas jet downstream of the supersonic nozzle.

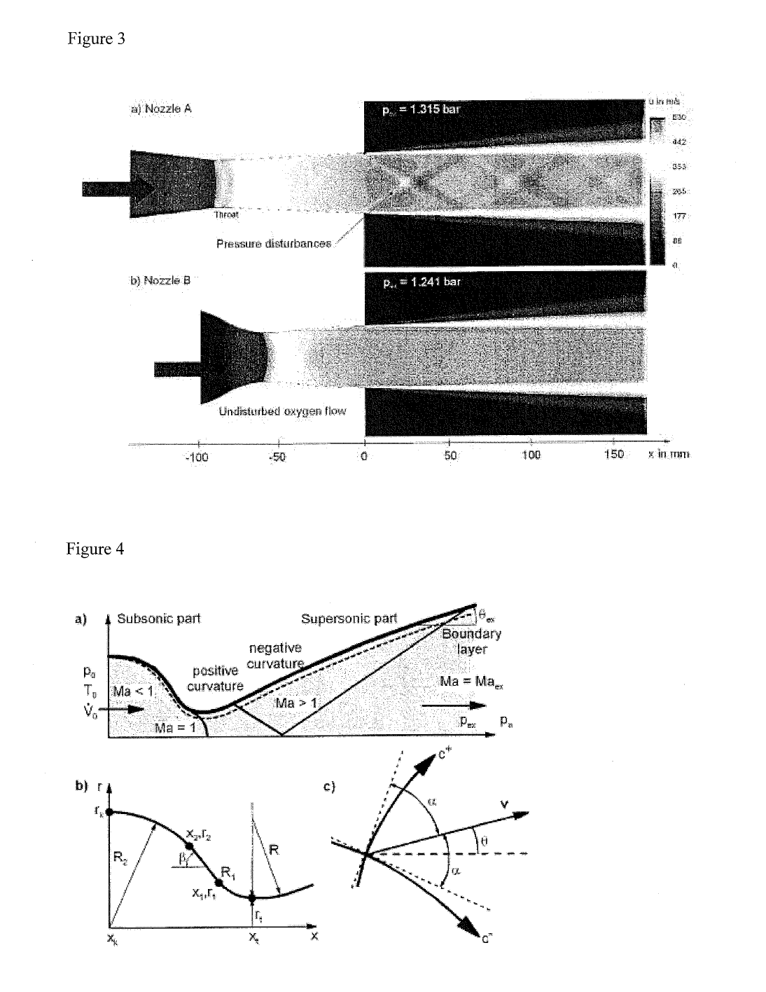

FIG. 3, supersonic nozzle A shows the result of a CFD simulation (CFD=Computational Fluid Dynamics) for a Laval nozzle designed with the conventional isentropic stream tube theory, as typically used for the injection of oxygen in the EAF, and which works exactly in the design point (design point: oxygen, inlet pressure pₒ=8.4 bar, inlet volumetric flow rate Vₒ=51.13 Nm³/min, ambient pressure pᵤ=1.23 bar).

In spite of the upstream pressure pₒ that was exactly adapted to the area ratio A*/Aₑ at the nozzle inlet, slight pressure disturbances are formed within and outside of the supersonic nozzle, which impair the jet efficiency. If the supersonic nozzle is moreover still operated ‘off-design point,’ the pressure irregularities still increase. Some of the manufacturers attempt to approximate the nozzle contour by means of a freely selected spline function, a hyperbolic function, or by means of sequencing different arcs. As a result of CFD simulation it has been realized, however, that even in these cases pressure irregularities occur within the supersonic nozzle.

Pursuant to the present disclosure, the purpose is to determine the optimal, bell-shaped axisymmetrical form of the Laval nozzle based upon a purely numerical process that is set up on a modified Method of Characteristics. This method takes into account the influence of friction in the boundary layer and thus what the displacement effect of the boundary layer has on the turbulent core.

Multi-dimensional flow effects are also taken into account. Because of the bell-shaped contour it is ensured that the supersonic nozzle will operate trouble-free and with low wear, that the jet impulse at the nozzle outlet is at its maximum, and that a long supersonic length of the gas jet is realized. A further, significant advantage is that the nozzle length is reduced by approximately 20-30% and copper material can be saved. This will significantly reduce the weight of the lance and/or of the injector, which simplifies the installation of the unit.

For this purpose, the ideal wall contour for the supersonic nozzle for the respective metallurgical unit is determined with a special, modified Method of Characteristic Curves purely numerically. The Method of Characteristic Curves is a process for resolving the partial gas dynamic differential equations. In this context, the Mach lines, i.e. the lines with slight pressure irregularities, which propagate with supersonic velocity and which are arranged at a defined angle to the local velocity vector, are used as the basis for the so-called clockwise and anti-clockwise characteristics. In accordance with these characteristics, the solution of the partial differential equations is known. In the present case, the Method of characteristics is coupled with a boundary layer correction, as a result of which the pulse reducing influence of the boundary layer in the Laval nozzle is taken into account. Using this purely numerical method, a class of nozzle contours is designed which are very suitable for use in metallurgical installations.

The typical contour of a supersonic nozzle is illustrated in FIG. 4a. It consists of a convergent subsonic part and a divergent supersonic part. The supersonic part is frequently also called expansion part.

FIG. 4a illustrates the developing boundary layer. Within this boundary layer, the gas is decelerated from the maximum velocity on the edge of the boundary layer down to zero velocity on the wall. The so-called no-slip-condition applies directly on the wall. The individual areas of the nozzle flow (Ma <1, Ma=1, Ma >1) are drawn in the Figure.

The mathematics of the entire method is complex and will therefore be only described rudimentarily.

The solution is based upon the following equations among other things:

a) Fundamental equation of the stationary, isentropic axisymmetrical gas flow.

$$( {a}^{2} - {u}^{2} ) \frac{\partial u}{\partial x} - 2 uv \frac{\partial v}{\partial x} + ( {a}^{2} - {v}^{2} ) ( \frac{\partial v}{\partial r} ) + \frac{{a}^{2} v}{r} = 0$$

u, v: flow velocity in the axial and radial direction
x, r: axial and radial coordinate
a: sound velocity
b) Numerical solution of the characteristics equations and the compatibility conditions according to the characteristics.

### Characteristics Equations:

$$( \frac{d r}{d x} ) c -= tan ( θ - α ) and ( \frac{d r}{d x} ) c += tan ( θ + α )$$

c−, c+: clockwise and anti-clockwise characteristics
θ: angle between the local velocity vector and the coordinate system; flow angle
α: Mach angle

### Compatibility Conditions According to the Characteristics:

$$d ( θ + v ) c -= \frac{1}{\sqrt{{Ma}^{2} - 1} - cot θ} \frac{dr}{r} and$$

$$d ( θ - v ) c += - \frac{1}{\sqrt{{Ma}^{2} - 1} + cot θ} \frac{dr}{r}$$

Ma: Mach number
v: Prandtl-Meyer angle
c) Sonic line and initial line in the nozzle throat are determined with the interference potential equations for axisymmetrical, compressible flows.

$$( κ + 1 ) {ϕ}_{x}^{′} {ϕ}_{xx}^{′} - {ϕ}_{rr}^{′} - \frac{{ϕ}_{r}^{′}}{r} = 0$$

φ′: Interference potential
d) The interference velocities are calculated with the critical sound velocity a*, i.e. u′=φ′ₓ and v′=φ′ᵣ.

$${u}^{′} ( x , r ) = kx + \frac{( κ + 1 ) {k}^{2} {r}^{2}}{4} and$$

$${v}^{′} ( x , r ) = \frac{( κ + 1 ) {k}^{2} xr}{2} + \frac{{( κ + 1 )}^{2} {k}^{3} {r}^{3}}{16}$$

k: constant

The initial values are calculated from the initial line up to the initial characteristic. In this instance, a special iteration method is used for the determination of the grid points and the associated flow parameters as well as for taking into account the curvature of the characteristics.

e) The expansion part of the supersonic nozzle with positive contour curvature is calculated from the initial characteristic up to the last expansion characteristic. In this instance, a special contour function is used of the form:

$${u}^{′} ( x , r ) = kx + \frac{( κ + 1 ) {k}^{2} {r}^{2}}{4} and$$

$${v}^{′} ( x , r ) = \frac{( κ + 1 ) {k}^{2} xr}{2} + \frac{{( κ + 1 )}^{2} {k}^{3} {r}^{3}}{16}$$

a,b,c: constants

Finally, the flow parameters are determined based upon the characteristics and the contour function. The design Mach number on the jet axis is controlled for this purpose.

f) The expansion part of the supersonic nozzle with negative contour curvature is determined by the last expansion characteristic and the Mach line from the axis point. The basis are [sic] the so-called backward characteristics c′ and the wall flow line.
g) For given values of rₖ, R₁, R₂ and β, the subsonic part of the supersonic nozzle is defined by special contour functions in the form of arcs, since no pressure irregularities can occur here, see FIG. 4b.

r=f(xₖ,rₖ,R₂) for x≦x₂

r=f(x₁,x₂,r₁,r₂) for x₂≦x≦x₁

r=f(xₜ,rₜ,R₁,R₂) for xₜ≦x≦xₜ

The result produced from the iterative calculation is an optimized, bell-shaped nozzle contour, such as shown as the supersonic nozzle B in FIG. 2.

For the illustrated application, the nozzle length reduces from l=142 mm to 100 mm, i.e. by roughly 30%. This means that a supersonic nozzle can be realized that is roughly 30% shorter and therefore also approximately 30% lighter in weight, accompanied by improved efficiency of the oxygen jet. This makes the replacement of a nozzle head considerably easier.

FIG. 3A illustrates a CFD simulation (CFD: Computational Fluid Dynamics) for a conventional supersonic nozzle with a level convergent inlet, an unvarying nozzle throat and a level divergent outlet. The supersonic nozzle is operated exactly in its design point and includes the following flow parameters: the gas medium is oxygen, the inlet pressure p₀=8.4 bar, the inlet volume Vₒ=51.13 Nm³/min, (Nm³ equals one standard cubic meter), and the ambient pressure pᵤ=1.23 bar. This simulation clearly shows that in the supersonic nozzle pursuant to FIG. 3A irregularities discharge at the outlet, which pass through the emerging jet as interference waves.

In FIG. 3B, the Laval supersonic nozzle pursuant to the present disclosure with its numerically determined bell-shaped walls was also simulated by CFD simulation. It can be immediately recognized that this supersonic nozzle, in spite of its clearly shorter design, produces a homogenous flow at the outlet, in which no irregularities can be recognized.

FIG. 4C shows the Mach lines which are characteristic curves of the gas dynamic fundamental equation. The characteristics c⁻ with the flow angle (θ−α) are designated as clockwise characteristics, i.e. right of the flow line. The characteristics c⁺ with the flow angle (θ+α) are designated as anti-clockwise characteristics i.e. left of the flow line; where v is the local velocity vector.

FIG. 3 shows the supersonic nozzle B according to the nozzle flow simulated by means of CFD for the design case. The entire oxygen jet in the supersonic nozzle is now free of interferences, contrary to the supersonic nozzle A in FIG. 3. In other words, the pressure irregularities which are promoting the flow detachment in the supersonic nozzle A which could still be seen with the otherwise same numerical conditions, have disappeared and the jet can emerge from the supersonic nozzle B without irregularities. In the present case, the exit angle θₑₓ of the gas from the supersonic nozzle is equal to zero degrees. Using the Method of Characteristics, it is however also possible to configure nozzle exit angles that are not equal to zero degrees.

FIG. 4A shows a supersonic nozzle with its subsonic area and its supersonic area and a corresponding boundary layer.

FIG. 4B shows the subsonic area of the supersonic nozzle with the corresponding radii designations, which result in a classic structure of the geometry, which is composed of pieces of arcs for the subsonic area. No pressure irregularities can occur in the subsonic part of the nozzle.

The typical fluidic constraints for the operation of supersonic nozzles in the metallurgical installations mentioned, appear as follows:

Injector nozzle/burner nozzle for an electric arc furnace (EAF):
Gas: oxygen, nitrogen, argon, natural gas, CO₂.
Inlet pressure in the supersonic nozzle: p₀=4-12 bar
Inlet volumetric flow rate: V₀=20-100 Nm³/min

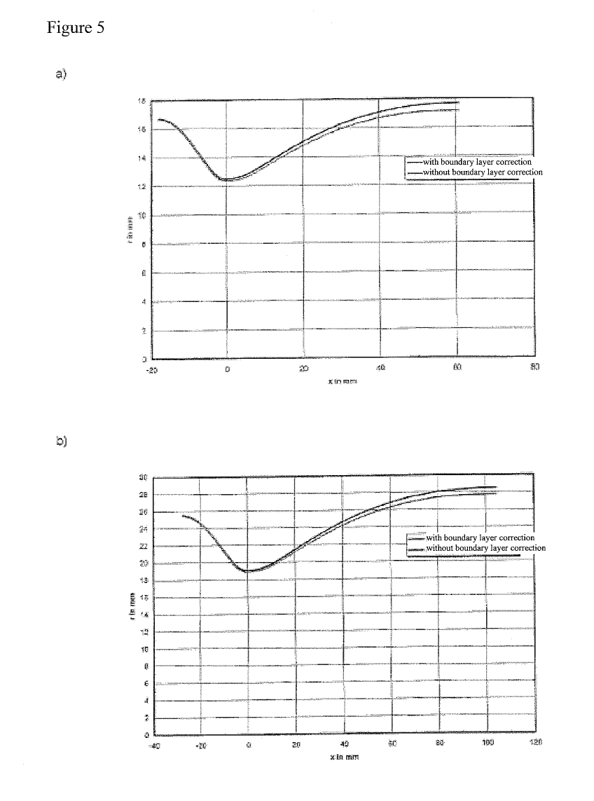

FIG. 5a shows an example of an EAF injector/burner nozzle in operation with oxygen, designed according to the numerical method, calculated with an inlet pressure pₒ=10 bar, an inlet volumetric flow rate Vₒ=50 Nm³/min and the ambient pressure pᵤ=1.013 bar. A calculation with and a calculation without correction of the boundary layer is represented. With the same volumetric flow rate, the supersonic nozzle must be configured somewhat bigger, due to the displacement effect of the boundary layer, which is somewhat closer to reality than the case without correction of the boundary layer.

Lance nozzle for a converter (AOD, BOF):
Gas: oxygen, nitrogen
Inlet pressure into the supersonic nozzle: pₒ=6-14 bar
Inlet volumetric flow rate: Vₒ=80-200 Nm³/min (for each supersonic nozzle in the lance head)

FIG. 5b shows an example of an individual nozzle for a lance operated with oxygen, designed according to the numerical method, calculated with an inlet pressure pₒ=12 bar, an inlet volumetric flow rate Vₒ=140 Nm³/min and the ambient pressure pᵤ=1.013 bar. Again a calculation with and a calculation without correction of the boundary layer is represented.

From the previously mentioned constraints, the following class of supersonic nozzles (nozzle group) results:

Gas: oxygen, nitrogen, argon, natural gas, CO₂
Inlet pressure into the supersonic nozzle: p₀=4-14 bar
Inlet volumetric flow rate: V₀=20-200 Nm³/min

The result thereof is the following group of nozzle shapes (for pᵤ=1.013 bar=const.):

| | | Radius in | | max. |
|---|---|---|---|---|
| | Volumetric | narrowest | Outlet | nozzle |
| Pressure | flow rate V₀ | cross-section | radius rₑ | length |
| p₀ in bar | in Nm/min | r* in mm | in mm | 1 in mm |
| 4 | 20 | 12.0 | 14.0 | 50 ± 20 |
| 4 | 200 | 39 | 44.0 | 160 ± 20 |
| 14 | 20 | 6 | 10.0 | 50 ± 20 |
| 14 | 200 | 21 | 33.0 | 160 ± 20 |

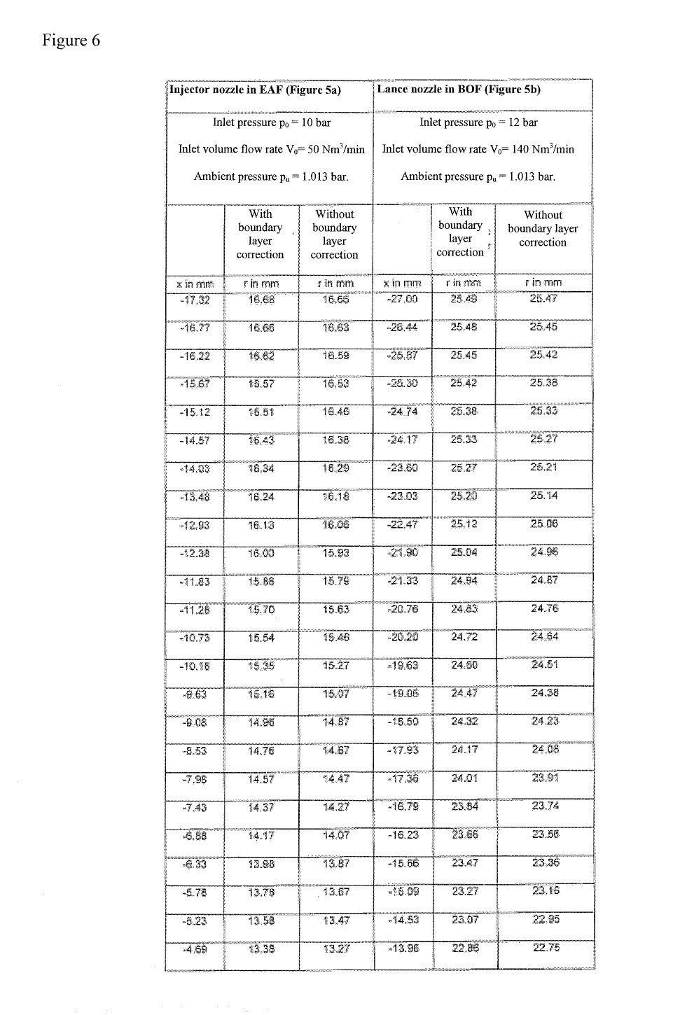

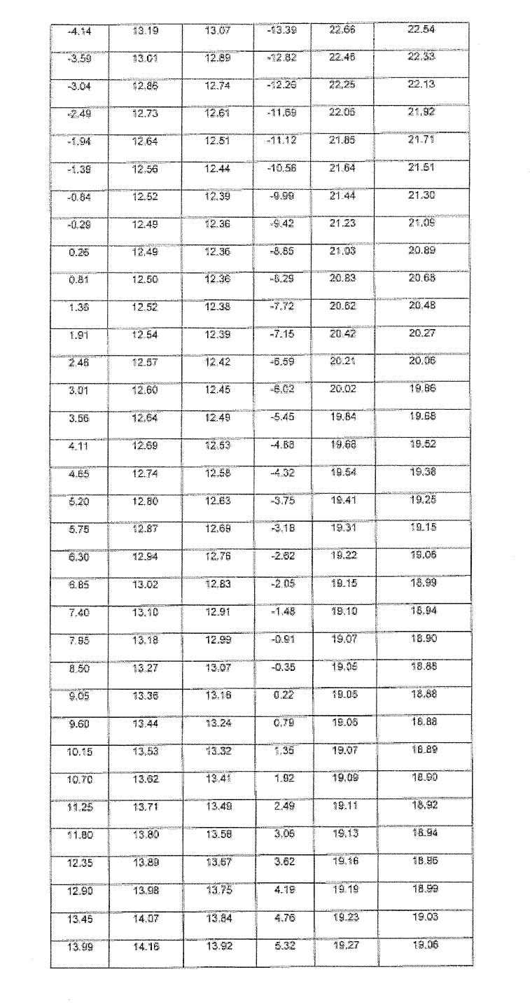

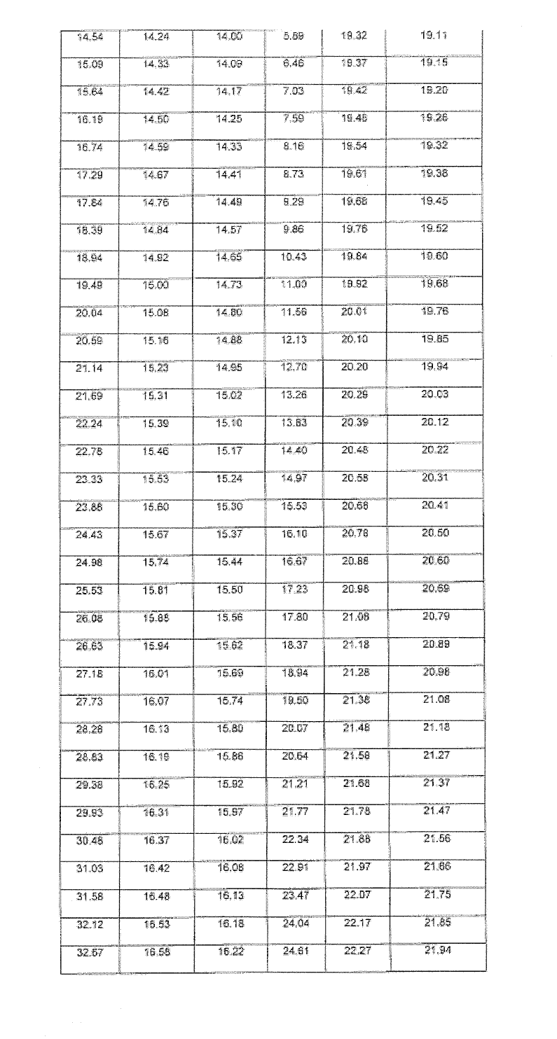

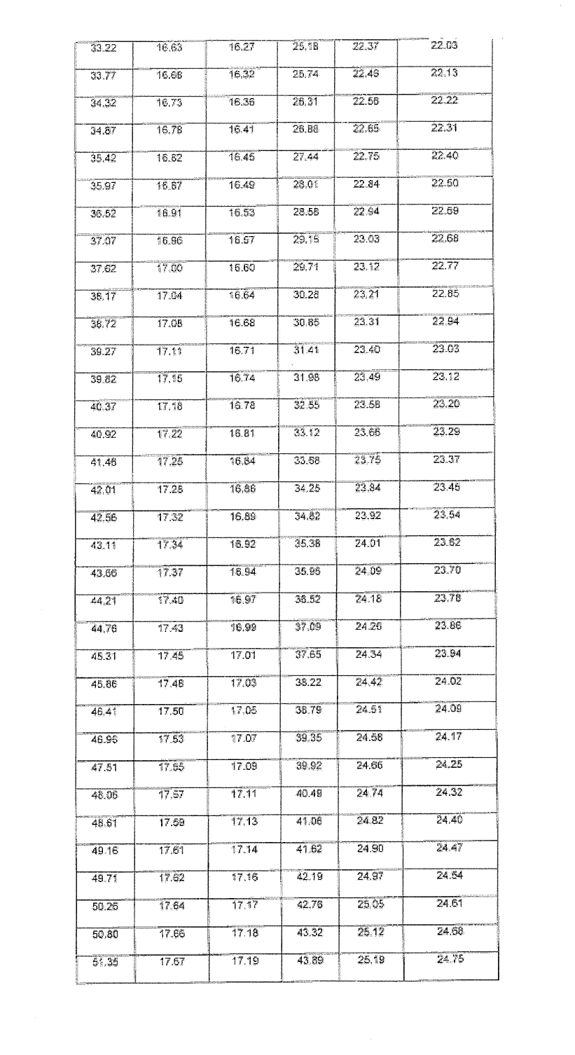

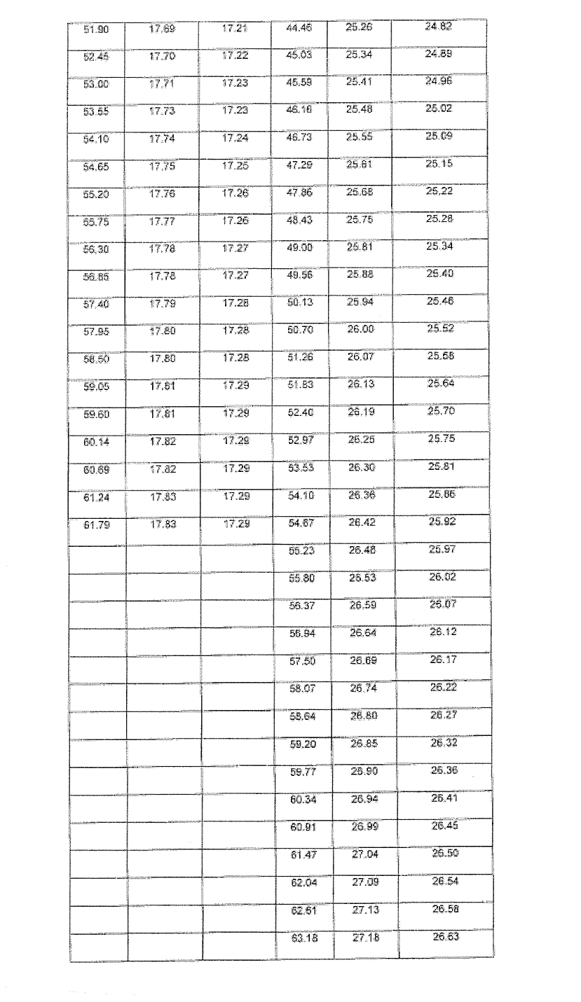

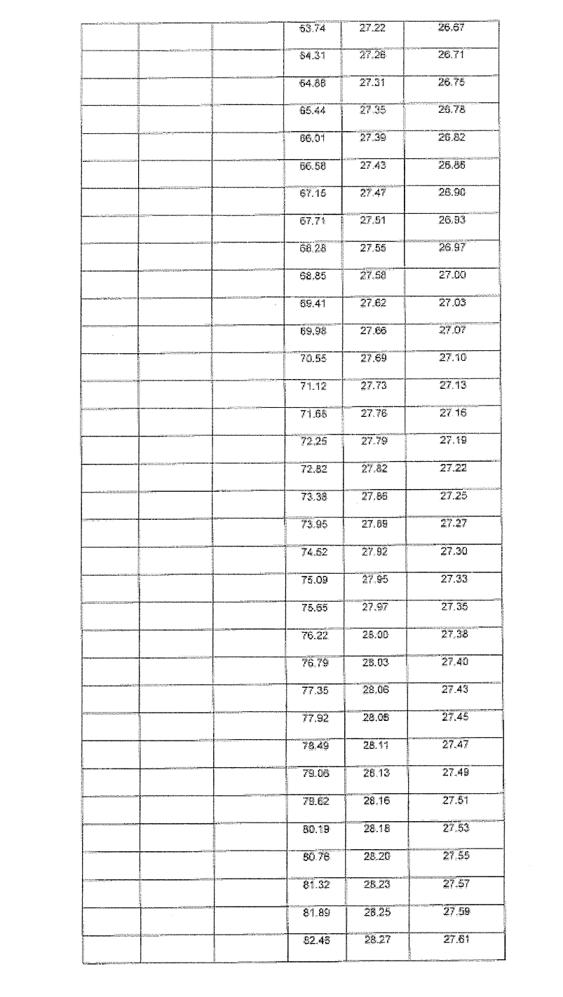

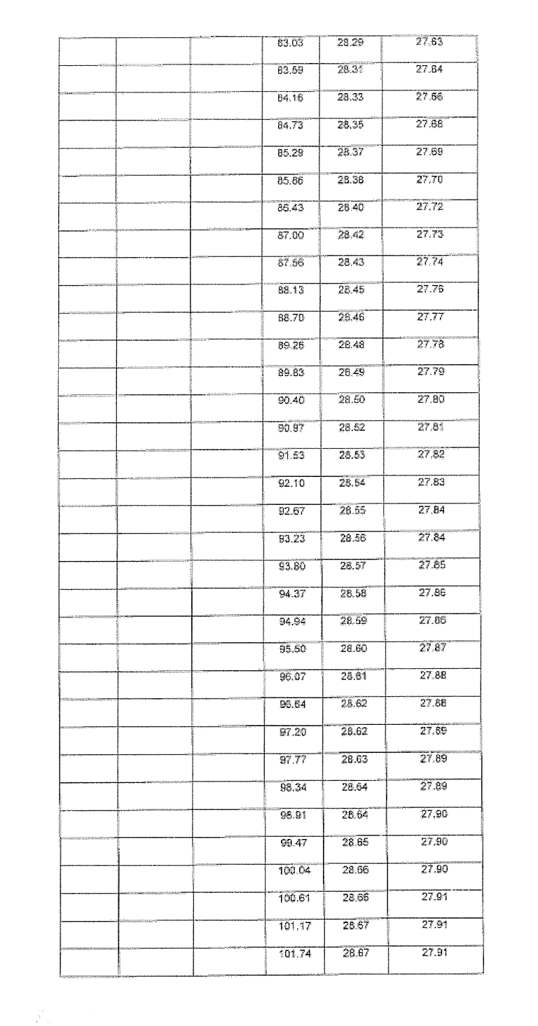

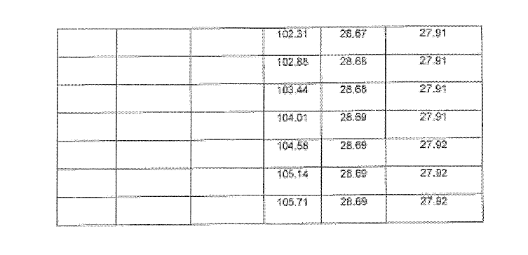

FIG. 6 shows a table for the axial and radial coordinates of both supersonic nozzles from FIG. 5.

1. A supersonic nozzle for use in metallurgical installations, in particular for the top blowing of a gas in a basic oxygen furnace (BOF), in an argon oxygen decarburization (AOD) converter or in an electric arc furnace (EAF), with a convergent portion and a divergent portion which are adjacent to each other at a nozzle throat (DK), characterized in that the inside contour of the supersonic nozzle corresponds to the contour determined numerically with a modified Method of Characteristics, and the supersonic nozzle is defined by the following group of nozzle shapes in their respective design case:

| | | Radius in | | max. |
|---|---|---|---|---|
| | Volumetric | narrowest | Outlet | nozzle |
| Pressure | flow rate V₀ | cross-section | radius rₑ | length |
| p₀ in bar | in Nm/min | r* in mm | in mm | 1 in mm |
| 4 | 20 | 12.0 | 14.0 | 50 ± 20 |
| 4 | 200 | 39 | 44.0 | 160 ± 20 |
| 14 | 20 | 6 | 10.0 | 50 ± 20 |
| 14 | 200 | 21 | 33.0 | 160 ± 20 |

wherein the ratio of the nozzle length l to the radius in the narrowest cross-section r*, i.e. l/r* is between 2.1 and 11.6, preferably between 2.1 and 8.3, even more preferably between 2.1 and 5.4, and even still more preferably between 2.1 and 5.0, and in particular comprises values of 11.6; 8.3; 5.4, 5.0; 4.8, 4.2; 4.1; 3.6; 3.3; 3.1 or 2.1.

2. (canceled)

3. The supersonic nozzle pursuant to claim 14, wherein the inner contour of the supersonic nozzle corresponds to the contour determined, which is determined by the numeric solution of the partial gas dynamic differential equations, in which the stationary, isentropic, axisymmetrical gas flow is represented by means of spatially discretized characteristics equations, taking into account corresponding conditions of compatibility.

4. The supersonic nozzle pursuant to claim 3, wherein with the solution of the partial, numerical differential equations, the influence of a friction-affected, boundary layer close to the wall is taken into account.

5. (canceled)

6. The supersonic nozzle pursuant to claim 1, wherein the convergent portion comprises a bell-shaped contour and the divergent portion comprises a bell-shaped contour, wherein the bell-shaped contours of the convergent portion and of the divergent portion are uniformly merging into one another on the nozzle throat.

7. The supersonic nozzle pursuant to claim 1, wherein the supersonic nozzle comprises cooling channels.

8. The supersonic nozzle pursuant to claim 1, wherein the interior contour of the divergent portion of the supersonic nozzle cannot be represented by a unique mathematical function.

9. (canceled)

10. The method pursuant to claim 15, wherein the contour is determined by the numeric solution of the partial gas dynamic differential equations, in which the stationary, isentropic, axisymmetrical gas flow is represented by means of spatially discretized characteristic equations, taking into account corresponding conditions of compatibility.

11. The method pursuant to claim 10, wherein the solution of the partial, numerical differential equations is corrected by the influence of a friction-affected, boundary layer close to the wall.

12. The supersonic nozzle for use in metallurgical installations, in particular for the top blowing of a gas in a basic oxygen furnace (BOF), in an argon oxygen decarburization (AOD) converter, or in an electrical arc furnace (EAF), characterized in that the inside contour of the supersonic nozzle corresponds to the contour determined numerically with a modified Method of Characteristics, and by the following dimensioned interior contour in the following design case:
Inlet pressure p₀ = 10 bar
Volumetric Inlet flow rate V₀ = 50
Nm³/min
Ambient pressure pᵤ = 1.013 bar

| | With | Without |
|---|---|---|
| | boundary | boundary |
| | layer | layer |
| | correction | correction |
| x in mm | r in mm | r in mm |
| −17.32 | 16.68 | 16.66 |
| −16.77 | 16.66 | 16.63 |
| −16.22 | 16.62 | 16.59 |
| −15.67 | 16.57 | 16.53 |
| −15.12 | 16.51 | 16.46 |
| −14.57 | 16.43 | 16.38 |
| −14.03 | 16.34 | 16.29 |
| −13.48 | 16.24 | 16.18 |
| −12.93 | 16.13 | 16.06 |
| −12.38 | 16.00 | 15.93 |
| −11.83 | 15.86 | 15.79 |
| −11.28 | 15.70 | 15.63 |
| −10.73 | 15.54 | 15.46 |
| −10.18 | 15.35 | 15.27 |
| −9.63 | 15.16 | 15.07 |
| −9.08 | 14.96 | 14.87 |
| −8.53 | 14.76 | 14.67 |
| −7.98 | 14.57 | 14.47 |
| −7.43 | 14.37 | 14.27 |
| −6.88 | 14.17 | 14.07 |
| −6.33 | 13.98 | 13.87 |
| −5.78 | 13.78 | 13.67 |
| −5.23 | 13.58 | 13.47 |
| −4.69 | 13.38 | 13.27 |
| −4.14 | 13.19 | 13.07 |
| −3.59 | 13.01 | 12.89 |
| −3.04 | 12.86 | 12.74 |
| −2.49 | 12.73 | 12.61 |
| −1.94 | 12.64 | 12.51 |
| −1.39 | 12.56 | 12.44 |
| −0.84 | 12.52 | 12.39 |
| −0.29 | 12.49 | 12.36 |
| 0.26 | 12.49 | 12.36 |
| 0.81 | 12.50 | 12.36 |
| 1.36 | 12.52 | 12.38 |
| 1.91 | 12.54 | 12.39 |
| 2.46 | 12.57 | 12.42 |
| 3.01 | 12.60 | 12.45 |
| 3.56 | 12.64 | 12.49 |
| 4.11 | 12.69 | 12.53 |
| 4.65 | 12.74 | 12.58 |
| 5.20 | 12.80 | 12.63 |
| 5.75 | 12.87 | 12.69 |
| 6.30 | 12.94 | 12.76 |
| 6.85 | 13.02 | 12.83 |
| 7.40 | 13.10 | 12.91 |
| 7.95 | 13.18 | 12.99 |
| 8.50 | 13.27 | 13.07 |
| 9.05 | 13.36 | 13.16 |
| 9.60 | 13.44 | 13.24 |
| 10.15 | 13.53 | 13.32 |
| 10.70 | 13.62 | 13.41 |
| 11.25 | 13.71 | 13.49 |
| 11.80 | 13.80 | 13.58 |
| 12.35 | 13.89 | 13.67 |
| 12.90 | 13.98 | 13.75 |
| 13.45 | 14.07 | 13.84 |
| 13.99 | 14.16 | 13.92 |
| 14.54 | 14.24 | 14.00 |
| 15.09 | 14.33 | 14.09 |
| 15.64 | 14.42 | 14.17 |
| 16.19 | 14.50 | 14.25 |
| 16.74 | 14.59 | 14.33 |
| 17.29 | 14.67 | 14.41 |
| 17.84 | 14.76 | 14.49 |
| 18.39 | 14.84 | 14.57 |
| 18.94 | 14.92 | 14.65 |
| 19.49 | 15.00 | 14.73 |
| 20.04 | 15.08 | 14.80 |
| 20.59 | 15.16 | 14.88 |
| 21.14 | 15.23 | 14.95 |
| 21.69 | 15.31 | 15.02 |
| 22.24 | 15.39 | 15.10 |
| 22.78 | 15.46 | 15.17 |
| 23.33 | 15.53 | 15.24 |
| 23.88 | 15.60 | 15.30 |
| 24.43 | 15.67 | 15.37 |
| 24.98 | 15.74 | 15.44 |
| 25.53 | 15.81 | 15.50 |
| 26.08 | 15.88 | 15.56 |
| 26.63 | 15.94 | 15.62 |
| 27.18 | 16.01 | 15.69 |
| 27.73 | 16.07 | 15.74 |
| 28.28 | 16.13 | 15.80 |
| 28.83 | 16.19 | 15.86 |
| 29.38 | 16.25 | 15.92 |
| 29.93 | 16.31 | 15.97 |
| 30.48 | 16.37 | 16.02 |
| 31.03 | 16.42 | 16.08 |
| 31.58 | 16.48 | 16.13 |
| 32.12 | 16.53 | 16.18 |
| 32.67 | 16.58 | 16.22 |
| 33.22 | 16.63 | 16.27 |
| 33.77 | 16.68 | 16.32 |
| 34.32 | 16.73 | 16.36 |
| 34.87 | 16.78 | 16.41 |
| 35.42 | 16.82 | 16.45 |
| 35.97 | 16.87 | 16.49 |
| 36.52 | 16.91 | 16.53 |
| 37.07 | 16.96 | 16.57 |
| 37.62 | 17.00 | 16.60 |
| 38.17 | 17.04 | 16.64 |
| 38.72 | 17.08 | 16.68 |
| 39.27 | 17.11 | 16.71 |
| 39.82 | 17.15 | 16.74 |
| 40.37 | 17.18 | 16.78 |
| 40.92 | 17.22 | 16.81 |
| 41.46 | 17.25 | 16.84 |
| 42.01 | 17.28 | 16.86 |
| 42.56 | 17.32 | 16.89 |
| 43.11 | 17.34 | 16.92 |
| 43.66 | 17.37 | 16.94 |
| 44.21 | 17.40 | 16.97 |
| 44.76 | 17.43 | 16.99 |
| 45.31 | 17.45 | 17.01 |
| 45.86 | 17.48 | 17.03 |
| 46.41 | 17.50 | 17.05 |
| 46.96 | 17.53 | 17.07 |
| 47.51 | 17.55 | 17.09 |
| 48.06 | 17.57 | 17.11 |
| 48.61 | 17.59 | 17.13 |
| 49.16 | 17.61 | 17.14 |
| 49.71 | 17.62 | 17.16 |
| 50.26 | 17.64 | 17.17 |
| 50.80 | 17.66 | 17.18 |
| 51.35 | 17.67 | 17.19 |
| 51.90 | 17.69 | 17.21 |
| 52.45 | 17.70 | 17.22 |
| 53.00 | 17.71 | 17.23 |
| 53.55 | 17.73 | 17.23 |
| 54.10 | 17.74 | 17.24 |
| 54.65 | 17.75 | 17.25 |
| 55.20 | 17.76 | 17.26 |
| 55.75 | 17.77 | 17.26 |
| 56.30 | 17.78 | 17.27 |
| 56.85 | 17.78 | 17.27 |
| 57.40 | 17.79 | 17.28 |
| 57.95 | 17.80 | 17.28 |
| 58.50 | 17.80 | 17.28 |
| 59.05 | 17.81 | 17.29 |
| 59.60 | 17.81 | 17.29 |
| 60.14 | 17.82 | 17.29 |
| 60.69 | 17.82 | 17.29 |
| 61.24 | 17.83 | 17.29 |
| 61.79 | 17.83 | 17.29 |

13. The supersonic nozzle for use in metallurgical installations, in particular for the top blowing of a gas in a basic oxygen furnace (BOF), in an argon oxygen decarburization (AOD) converter, or in an electrical arc furnace (EAF), characterized in that the inside contour of the supersonic nozzle corresponds to the contour determined numerically with a modified Method of Characteristics, and by the following dimensioned interior contour in the following design case:
Inlet pressure p₀ = 12 bar
Volumetric Inlet flow rate V₀ = 140
Nm³/min
Ambient pressure pᵤ = 1.013 bar

| | With | Without |
|---|---|---|
| | boundary | boundary |
| | layer | layer |
| | correction | correction |
| x in mm | r in mm | r in mm |
| −27.00 | 25.49 | 25.47 |
| −26.44 | 25.48 | 25.45 |
| −25.87 | 25.45 | 25.42 |
| −25.30 | 25.42 | 25.38 |
| −24.74 | 25.38 | 25.33 |
| −24.17 | 25.33 | 25.27 |
| −23.60 | 25.27 | 25.21 |
| −23.03 | 25.20 | 25.14 |
| −22.47 | 25.12 | 25.06 |
| −21.90 | 25.04 | 24.96 |
| −21.33 | 24.94 | 24.87 |
| −20.76 | 24.83 | 24.76 |
| −20.20 | 24.72 | 24.64 |
| −19.63 | 24.60 | 24.51 |
| −19.06 | 24.47 | 24.38 |
| −18.50 | 24.32 | 24.23 |
| −17.93 | 24.17 | 24.08 |
| −17.36 | 24.01 | 23.91 |
| −16.79 | 23.84 | 23.74 |
| −16.23 | 23.66 | 23.56 |
| −15.66 | 23.47 | 23.36 |
| −15.09 | 23.27 | 23.16 |
| −14.53 | 23.07 | 22.95 |
| −13.96 | 22.86 | 22.75 |
| −13.39 | 22.66 | 22.54 |
| −12.82 | 22.46 | 22.33 |
| −12.26 | 22.25 | 22.13 |
| −11.69 | 22.05 | 21.92 |
| −11.12 | 21.85 | 21.71 |
| −10.56 | 21.64 | 21.51 |
| −9.99 | 21.44 | 21.30 |
| −9.42 | 21.23 | 21.09 |
| −8.85 | 21.03 | 20.89 |
| −8.29 | 20.83 | 20.68 |
| −7.72 | 20.62 | 20.48 |
| −7.15 | 20.42 | 20.27 |
| −6.59 | 20.21 | 20.06 |
| −6.02 | 20.02 | 19.86 |
| −5.45 | 19.84 | 19.68 |
| −4.88 | 19.68 | 19.52 |
| −4.32 | 19.54 | 19.38 |
| −3.75 | 19.41 | 19.25 |
| −3.18 | 19.31 | 19.15 |
| −2.62 | 19.22 | 19.06 |
| −2.05 | 19.15 | 18.99 |
| −1.48 | 19.10 | 18.94 |
| −0.91 | 19.07 | 18.90 |
| −0.35 | 19.05 | 18.88 |
| 0.22 | 19.05 | 18.88 |
| 0.79 | 19.06 | 18.88 |
| 1.35 | 19.07 | 18.89 |
| 1.92 | 19.09 | 18.90 |
| 2.49 | 19.11 | 18.92 |
| 3.06 | 19.13 | 18.94 |
| 3.62 | 19.16 | 18.96 |
| 4.19 | 19.19 | 18.99 |
| 4.76 | 19.23 | 19.03 |
| 5.32 | 19.27 | 19.06 |
| 5.89 | 19.32 | 19.11 |
| 6.46 | 19.37 | 19.15 |
| 7.03 | 19.42 | 19.20 |
| 7.59 | 19.48 | 19.26 |
| 8.16 | 19.54 | 19.32 |
| 8.73 | 19.61 | 19.38 |
| 9.29 | 19.68 | 19.45 |
| 9.86 | 19.76 | 19.52 |
| 10.43 | 19.84 | 19.60 |
| 11.00 | 19.92 | 19.68 |
| 11.56 | 20.01 | 19.76 |
| 12.13 | 20.10 | 19.85 |
| 12.70 | 20.20 | 19.94 |
| 13.26 | 20.29 | 20.03 |
| 13.83 | 20.39 | 20.12 |
| 14.40 | 20.48 | 20.22 |
| 14.97 | 20.58 | 20.31 |
| 15.53 | 20.68 | 20.41 |
| 16.10 | 20.78 | 20.50 |
| 16.67 | 20.88 | 20.60 |
| 17.23 | 20.98 | 20.69 |
| 17.80 | 21.08 | 20.79 |
| 18.37 | 21.18 | 20.89 |
| 18.94 | 21.28 | 20.98 |
| 19.50 | 21.38 | 21.08 |
| 20.07 | 21.48 | 21.18 |
| 20.64 | 21.58 | 21.27 |
| 21.21 | 21.68 | 21.37 |
| 21.77 | 21.78 | 21.47 |
| 22.34 | 21.88 | 21.56 |
| 22.91 | 21.97 | 21.66 |
| 23.47 | 22.07 | 21.75 |
| 24.04 | 22.17 | 21.85 |
| 24.61 | 22.27 | 21.94 |
| 25.18 | 22.37 | 22.03 |
| 25.74 | 22.46 | 22.13 |
| 26.31 | 22.56 | 22.22 |
| 26.88 | 22.65 | 22.31 |
| 27.44 | 22.75 | 22.40 |
| 28.01 | 22.84 | 22.50 |
| 28.58 | 22.94 | 22.59 |
| 29.15 | 23.03 | 22.68 |
| 29.71 | 23.12 | 22.77 |
| 30.28 | 23.21 | 22.85 |
| 30.85 | 23.31 | 22.94 |
| 31.41 | 23.40 | 23.03 |
| 31.98 | 23.49 | 23.12 |
| 32.55 | 23.58 | 23.20 |
| 33.12 | 23.66 | 23.29 |
| 33.68 | 23.75 | 23.37 |
| 34.25 | 23.84 | 23.45 |
| 34.82 | 23.92 | 23.54 |
| 35.38 | 24.01 | 23.62 |
| 35.95 | 24.09 | 23.70 |
| 36.52 | 24.18 | 23.78 |
| 37.09 | 24.26 | 23.86 |
| 37.65 | 24.34 | 23.94 |
| 38.22 | 24.42 | 24.02 |
| 38.79 | 24.51 | 24.09 |
| 39.35 | 24.58 | 24.17 |
| 39.92 | 24.66 | 24.25 |
| 40.49 | 24.74 | 24.32 |
| 41.06 | 24.82 | 24.40 |
| 41.62 | 24.90 | 24.47 |
| 42.19 | 24.97 | 24.54 |
| 42.76 | 25.05 | 24.61 |
| 43.32 | 25.12 | 24.68 |
| 43.89 | 25.19 | 24.75 |
| 44.46 | 25.26 | 24.82 |
| 45.03 | 25.34 | 24.89 |
| 45.59 | 25.41 | 24.96 |
| 46.16 | 25.48 | 25.02 |
| 46.73 | 25.55 | 25.09 |
| 47.29 | 25.61 | 25.15 |
| 47.86 | 25.68 | 25.22 |
| 48.43 | 25.75 | 25.28 |
| 49.00 | 25.81 | 25.34 |
| 49.56 | 25.88 | 25.40 |
| 50.13 | 25.94 | 25.46 |
| 50.70 | 26.00 | 25.52 |
| 51.26 | 26.07 | 25.58 |
| 51.83 | 26.13 | 25.64 |
| 52.40 | 26.19 | 25.70 |
| 52.97 | 26.25 | 25.75 |
| 53.53 | 26.30 | 25.81 |
| 54.10 | 26.36 | 25.86 |
| 54.67 | 26.42 | 25.92 |
| 55.23 | 26.48 | 25.97 |
| 55.80 | 26.53 | 26.02 |
| 56.37 | 26.59 | 26.07 |
| 56.94 | 26.64 | 26.12 |
| 57.50 | 26.69 | 26.17 |
| 58.07 | 26.74 | 26.22 |
| 58.64 | 26.80 | 26.27 |
| 59.20 | 26.85 | 26.32 |
| 59.77 | 26.90 | 26.36 |
| 60.34 | 26.94 | 26.41 |
| 60.91 | 26.99 | 26.45 |
| 61.47 | 27.04 | 26.50 |
| 62.04 | 27.09 | 26.54 |
| 62.61 | 27.13 | 26.58 |
| 63.18 | 27.18 | 26.63 |
| 63.74 | 27.22 | 26.67 |
| 64.31 | 27.26 | 26.71 |
| 64.88 | 27.31 | 26.75 |
| 65.44 | 27.35 | 26.78 |
| 66.01 | 27.39 | 26.82 |
| 66.58 | 27.43 | 26.86 |
| 67.15 | 27.47 | 26.90 |
| 67.71 | 27.51 | 26.93 |
| 68.28 | 27.55 | 26.97 |
| 68.85 | 27.58 | 27.00 |
| 69.41 | 27.62 | 27.03 |
| 69.98 | 27.66 | 27.07 |
| 70.55 | 27.69 | 27.10 |
| 71.12 | 27.73 | 27.13 |
| 71.68 | 27.76 | 27.16 |
| 72.25 | 27.79 | 27.19 |
| 72.82 | 27.82 | 27.22 |
| 73.38 | 27.86 | 27.25 |
| 73.95 | 27.89 | 27.27 |
| 74.52 | 27.92 | 27.30 |
| 75.09 | 27.95 | 27.33 |
| 75.65 | 27.97 | 27.35 |
| 76.22 | 28.00 | 27.38 |
| 76.79 | 28.03 | 27.40 |
| 77.35 | 28.06 | 27.43 |
| 77.92 | 28.08 | 27.45 |
| 78.49 | 28.11 | 27.47 |
| 79.06 | 28.13 | 27.49 |
| 79.62 | 28.16 | 27.51 |
| 80.19 | 28.18 | 27.53 |
| 80.76 | 28.20 | 27.55 |
| 81.32 | 28.23 | 27.57 |
| 81.89 | 28.25 | 27.59 |
| 82.46 | 28.27 | 27.61 |
| 83.03 | 28.29 | 27.63 |
| 83.59 | 28.31 | 27.64 |
| 84.16 | 28.33 | 27.66 |
| 84.73 | 28.35 | 27.68 |
| 85.29 | 28.37 | 27.69 |
| 85.86 | 28.38 | 27.70 |
| 86.43 | 28.40 | 27.72 |
| 87.00 | 28.42 | 27.73 |
| 87.56 | 28.43 | 27.74 |
| 88.13 | 28.45 | 27.76 |
| 88.70 | 28.46 | 27.77 |
| 89.26 | 28.48 | 27.78 |
| 89.83 | 28.49 | 27.79 |
| 90.40 | 28.50 | 27.80 |
| 90.97 | 28.52 | 27.81 |
| 91.53 | 28.53 | 27.82 |
| 92.10 | 28.54 | 27.83 |
| 92.67 | 28.55 | 27.84 |
| 93.23 | 28.56 | 27.84 |
| 93.80 | 28.57 | 27.85 |
| 94.37 | 28.58 | 27.86 |
| 94.94 | 28.59 | 27.86 |
| 95.50 | 28.60 | 27.87 |
| 96.07 | 28.61 | 27.88 |
| 96.64 | 28.62 | 27.88 |
| 97.20 | 28.62 | 27.89 |
| 97.77 | 28.63 | 27.89 |
| 98.34 | 28.64 | 27.89 |
| 98.91 | 28.64 | 27.90 |
| 99.47 | 28.65 | 27.90 |
| 100.04 | 28.66 | 27.90 |
| 100.61 | 28.66 | 27.91 |
| 101.17 | 28.67 | 27.91 |
| 101.74 | 28.67 | 27.91 |
| 102.31 | 28.67 | 27.91 |
| 102.88 | 28.68 | 27.91 |
| 103.44 | 28.68 | 27.91 |
| 104.01 | 28.69 | 27.91 |
| 104.58 | 28.69 | 27.92 |
| 105.14 | 28.69 | 27.92 |
| 105.71 | 28.69 | 27.92 |

14. A supersonic nozzle for use in metallurgical installations, in particular for the top blowing of a gas in a basic oxygen furnace (BOF), in an argon oxygen decarburization (AOD) converter or in an electric arc furnace (EAF), with a convergent portion and a divergent portion which are adjacent to each other at a nozzle throat (DK), characterized in that the inside contour of the supersonic nozzle corresponds to the contour determined numerically with a modified Method of Characteristics, wherein the ratio of the nozzle length l to the radius in the narrowest cross-section r*, i.e. l/r* is between 2.1 and 11.6, preferably between 2.1 and 8.3, even more preferably between 2.1 and 5.4, and even still more preferably between 2.1 and 5.0, and in particular comprises values of 11.6; 8.3; 5.4, 5.0; 4.8, 4.2; 4.1; 3.6; 3.3; 3.1 or 2.1.

15. The method for determination of the dimensions of a supersonic nozzle, which is used in metallurgical installations, in particular for the top blowing of a gas in a basic oxygen furnace (BOF), in an argon oxygen decarburization (AOD) converter or in an electric arc furnace (EAF), with a convergent portion and a divergent portion which are adjacent to each other at a nozzle throat (DK), wherein the method comprises the step of:
determining a contour numerically with a modified Method of Characteristics, and designing the interior contour of the supersonic nozzle by means of the contour determined, and wherein the ratio of the nozzle length l to the radius in the narrowest cross-section r*, i.e. l/r* is between 2.1 and 11.6, preferably between 2.1 and 8.3, even more preferably between 2.1 and 5.4, and even still more preferably between 2.1 and 5.0, and in particular comprises values of 11.6; 8.3; 5.4, 5.0; 4.8, 4.2; 4.1; 3.6; 3.3; 3.1 or 2.1.

16. The supersonic nozzle pursuant to claim 14, wherein the convergent portion comprises a bell-shaped contour and the divergent portion comprises a bell-shaped contour, wherein the bell-shaped contours of the convergent portion and of the divergent portion are uniformly merging into one another on the nozzle throat.

17. The supersonic nozzle pursuant to claim 14, wherein the supersonic nozzle comprises cooling channels.

18. The supersonic nozzle pursuant to claim 14, wherein the interior contour of the divergent portion of the supersonic nozzle cannot be represented by a unique mathematical function.
